(19) United States
(12) Patent Application Publication
(10) Pub. No.: US 2020/0145826 A1
(43) Pub. Date: May 7, 2020

(54) OBJECT WITH QR CODE ENCRYPTED WIFI NETWORK PASSWORD

(71) Applicant: Griffin Katz, New York, NY (US)

(72) Inventor: Griffin Katz, New York, NY (US)

(21) Appl. No.: 16/259,362

(22) Filed: Jan. 28, 2019

Related U.S. Application Data
(60) Provisional application No. 62/756,998, filed on Nov. 7, 2018.

(51) Int. Cl. H04W 12/06; G06K 19/06; G06K 7/14; G06K 7/10; H04L 29/06

(52) U.S. Cl. CPC H04W 12/06; G06K 19/06037; G06K 19/06028; H04L 63/083; G06K 7/1417; G06K 7/10722; G06K 7/1413

(57) ABSTRACT

An information providing apparatus is described. The information providing apparatus includes an information platform. The information providing apparatus also includes ink printed upon the information platform representing an encrypted machine readable indicia. The coded machine readable indicia has encrypted therein at least a WiFi network password.

### REFERENCE TO RELATED APPLICATIONS

This Application is a nonprovisional application claiming priority to U.S. Provisional Patent Application No. 62/756,998, filed on Nov. 7, 2018, entitled “QR Code on drink coaster to provide WiFi password and other encrypted material relatedness to the business”, to inventor Griffin Katz, which is herein incorporated by reference in its entirety.

### BACKGROUND

Many businesses make available WiFi connectivity to the internet for their patrons or visitors. Often, patrons do not have cellular data or access to the internet (i.e. poor cellular service, foreigners traveling, or simply people who don't want to use up their data) so when visiting a business, they must figure out how to gain access to the secured, locked WiFi network However, many businesses conventionally lock their WiFi to prevent unauthorized use (i.e. someone standing outside/near a business that has unlocked WiFi, can gain full access to their WiFi network. This presents a problem to patrons and visitors because they need to figure out how to get the appropriate password. For example, a customer visiting a bar that offers WiFi service to its patrons, may come into the bar and wish to access the WiFi network. To do so, the customer needs to know the WiFi Password. Conventionally, one would have to get up and ask the bartender for the password or look for it written on a wall somewhere. This method is not only cumbersome, but most importantly, it is extraordinarily insecure. Traditionally, upon request, the password is simply just written on a piece of paper (which the persons can keep for further, unauthorized access). This method not only provides a simpler method of providing WiFi passwords to patrons or visitors to a wide range of establishments and businesses, but most important, ensures the business WiFi network will be secure and only authorized patrons of the establishment can gain access to the WiFi network. Either solution for getting the password is cumbersome. Accordingly, there is a need for a simpler method of providing WiFi passwords to patrons or visitors to a wide range of establishments and businesses.

### SUMMARY

An exemplary embodiment relates to an information providing apparatus. The information providing apparatus includes an information platform. The information providing apparatus also includes ink printed upon the information platform representing an encrypted machine readable indicia. The coded machine readable indicia has encrypted therein at least a WiFi network password.

Another exemplary embodiment relates to a method of providing encrypted information to people. The method also includes sending the information to be encrypted to a server running a customization website. Further the method includes choosing the look of an information platform. Further still, the method relates to encrypting the information in a machine readable code and printing the machine readable code on the information platform. Yet further still, the method relates to sending the information platform to a business and providing the people with the printed information platform by the business.

Yet another exemplary embodiment relates to an information providing apparatus. The information providing apparatus includes a means for providing information. The information providing apparatus also includes a means for marking the information platform in a form representing a coded machine readable indicia, the coded machine readable indicia having encrypted therein at least a WiFi network password.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a coaster in accordance with the invention.

FIG. 2 is an exemplary embodiment of a system of using the coaster of FIG. 1

FIG. 3 is an exemplary embodiment of a process for creating the coaster of FIG. 1

The use of the same symbols in different drawings typically indicates similar or identical items unless context dictates otherwise.

### DETAILED DESCRIPTION

In accordance with an exemplary embodiment, customers to various businesses may need WiFi passwords when the business has a locked WiFi. Such businesses may be bars, restaurants, event locations, offices, etc. In accordance with an exemplary embodiment, a user at any bar, restaurant, event location, etc. can open up a camera app on their mobile phone and scan a QR code which contains an encrypted version of the password. The mobile phone app is able to resolve the password from the QR code and use it to logon to the WiFi network.

An advantage to this method of communicating WIFi passwords for patrons and visitors is that it protects the WiFi network name and password information. This system prevents businesses from sharing passwords with the general public by, for example, having the password on a piece of paper. Instead, the password is encrypted in a QR code that can be handed out to customers of the specific business.

In an exemplary embodiment, WiFi passwords are secure and encrypted onto a QR code. This protects owners from sharing password information in an unsecure, breachable, manner such as they do currently by writing out exact password and revealing it to all on a piece of paper, or the like. This prevents passwords from being leaked to all. Business owners can securely give out their WiFi password in a seamless, secure, and encrypted way via scanning the QR code with an iPhone or QR-compatible mobile phone. In some exemplary embodiments not only is the WiFi password encrypted onto a QR code, but the WFi network name (or SSID) may be stored as well.

When a patron enters a bar or restaurant that has a WiFi network open to patrons, instead of having to ask a host, a waiter, employee, etc. for the business' WiFi password, the patron simply scans a QR code made available to them. In accordance with an exemplary embodiment the QR code may be given out on a coaster or business card or any other types of printed media by the business owners to its customers. The password is shared with the patron via the QR code printed on the coaster or business card simply by opening up the camera on any iPhone or other mobile phone and pointing it at the QR bar code. The password will be automatically shared once the mobile phone recognizes and decrypts the QR code.

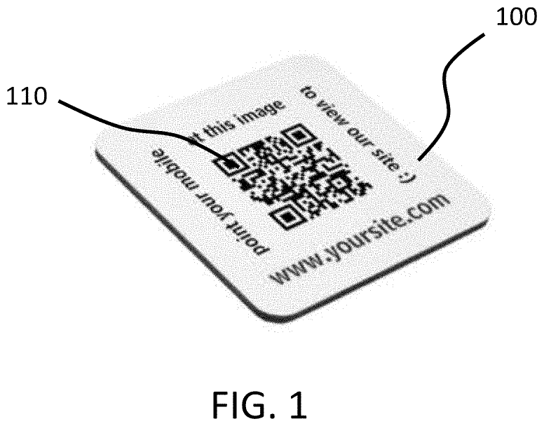

Referring now to FIG. 1, an exemplary embodiment of a disposable coaster 100 is depicted. Coaster 100 is representative of any of a variety of media which can be printed on, such as flyers, business cards, and the like. Coaster 100 is depicted with a QR code 110 printed thereon. QR code 100 is representative of any of a variety of visual digital code formats which are useable to encode or encrypt information in a machine-readable format. In the exemplary embodiment depicted, QR code 110 may be encoded or encrypted with a WiFi Network Password. Further, coaster 100 is representative of a printable media which may contain any type of printed graphics or texts in addition to the QR code. The additional printed graphics or text may be decorative or informative in nature without departing from the scope of the invention. The printed graphics include but are not limited to for example, any logo, image, symbol, color, etc.

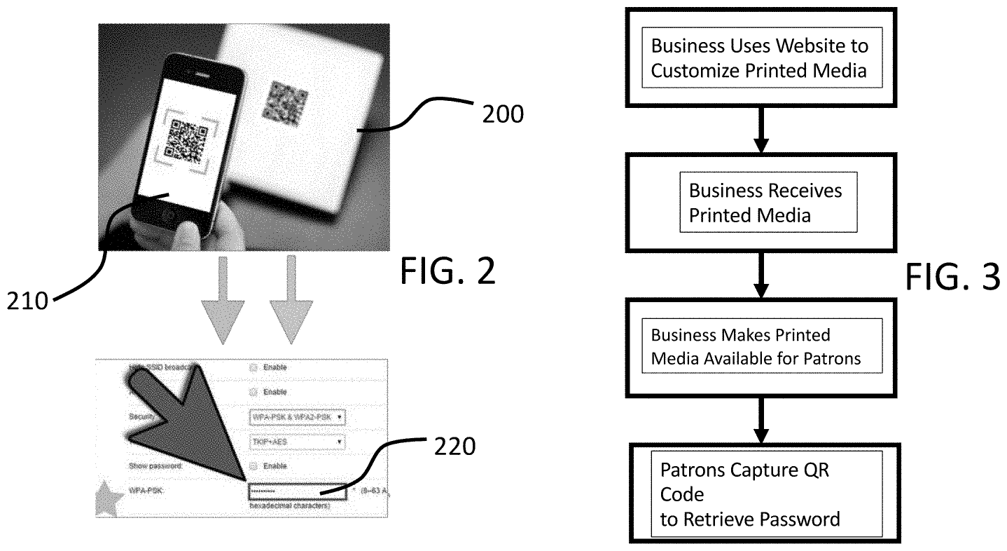

Referring now to FIG. 2, a coaster 200 is depicted with a QR code printed thereon. A mobile phone 210 is depicted using an app that uses the camera of mobile phone 210 to capture the QR code. The QR code is decrypted and a WiFi Password is automatically populated in a Password field 220 of a WiFi Network logon screen. In accordance with an exemplary embodiment, the actual text version of the password is never seen by the user, therefore although useable by patrons, the actual password remains concealed.

Conventionally, passwords are written down on a piece of paper or posted up on a sign where it is inaccessible to or unseen by many customers. With the QR code printed on a business card or coaster a business can securely share the business's WiFi password and make it very accessible to guests or patrons.

Various varieties of printed media may include, but are not limited to a coaster, a business card, and a business menu that has a scannable QR code printed on it for sharing encrypted data to the Business customers. Primarily, the product will be used to share a business's WiFi password to its customers in a safe, secure, and encrypted manner. Additionally, if the Business/Company would like to share any other sensitive information with its customers, the QR code printed on a coaster, can be specifically encrypted for any sensitive information that the business wishes to share (this may include the network SSID or other information). It should be noted that the QR code can be printed on any type of printable media or may even be displayed on a display screen.

Referring now to FIG. 3, a process diagram is provided depicting the process in which a business creates and shares encrypted WiFi password information. In a first step, a representative of the business goes on a third-party website that will allow the representative to customize printed media (such as but not limited to a coaster) with a generated a QR code for the provided SSID and password of the business. The representative places an order for the media and in a second step receives the printed media (in-person, by mail, or other courier). The printed media includes a QR code on any merchandise that they customized (i.e. drink coaster, business card, etc.). In a third step of the process depicted in FIG. 3, the business makes the printed media available to visitors or patrons of the business who may wish to and are invited to access the business's WiFi network. In a fourth step of the process depicted in FIG. 3, patrons or visitors to the business who receive the printed media and wish to access the WiFi network will use their mobile phone or other mobile device to capture the QR code from the printed media. For example, a patron or visitor will open up a camera app and scan the QR code. The app will decrypt and automatically populate the WiFi network password field of a WiFi network login screen of the associated SSID. The actual WiFi password remains secure and encrypted because it cannot be viewed by the user. On many mobile devices it has been required for a user to use a QR code that a user first download a QR code reader app onto the mobile device. When a QR code is to be decoded, a user of the mobile device would open up the QR code reader app, position the camera appropriately and then press a button to capture the QR code. At that point the mobile device app would decode the QR code information for use by the mobile device. In more recent mobile devices, this procedure has been built directly into the phone's camera app. Accordingly, on more recent mobile devices, a user merely opens the camera app for the mobile device and points the camera at the QR code. The camera app automatically detects the presence of a QR code and automatically captures and decodes the QR code without any user interaction. Thus, using more recent mobile phones with this ability streamlines the process of obtaining a WiFi password for an establishment.

This action of pointing the phone camera and automatically joining (“point and join”) a WiFi network significantly streamlines and automates gaining access to a WiFi network. Conventionally multiple steps would have been required to join a WiFi network including the typing of a potentially long and random string of letters, numbers, and symbols in order to gain access. The methods and apparatuses described here allow users to gain access to a WiFi network in essentially one step, i.e. pointing the mobile device camera at a QR code, for example.

In an exemplary embodiment, the physical item of choice that is needed by the business can be any of a variety of printed items, including but not limited to a coaster, a business card, a business menu, a restaurant menu, an event flyer, marketing materials, signs and posters, office stationary, post cards, brochures, rack cards, door hangers, presentation folders, table tents, promo products, bookmarks, office supplies, magnets, promotional materials, labels and stickers, paper and photo coasters (virtually any item that can have QR code printed on it). A secure website is used for business owners to fully customize their printed media to their business logo, etc. and then, securely send their business WiFi password for coaster customization and WiFi encryption] The password is then encrypted and the business's password is generated into a QR code. When the business receives the printed media, the business makes the printed media available to customers. When the customer sees the printed QR code, the customer uses a phone (or other mobile device) that is able to scan QR codes, to decrypt and utilize the WiFi network password.

Conventionally businesses may put their WiFi passwords, visible to patrons for unauthorized access, on large poster boards at their establishment or publicly display it all around the business establishment. This allows non-customers to access their WiFi without permission. In accordance with an exemplary embodiment a person uses the scannable QR code printed on a coaster or business card to prevent people to gain unauthorized access to a business's or company's WiFi. In addition to the WiFi Password other information may be encrypted within the QR code which a business may wish to provide to a user.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently.

Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. An information providing apparatus, comprising:
an information platform; and
ink printed upon the information platform representing an encrypted machine readable indicia, the coded machine readable indicia having encrypted therein at least a WiFi network password.

2. The information providing apparatus of claim 1, wherein machine readable indicia includes a bar code.

3. The information providing apparatus of claim 1, wherein machine readable indicia includes a QR code.

4. The information providing apparatus of claim 1, wherein the machine readable indicia is read by a mobile phone.

5. The information providing apparatus of claim 1, wherein the machine readable indicia is read by a mobile phone running an app and the app automatically provides the WiFi password to a WiFi network login screen.

6. The information providing apparatus of claim 1, wherein the information platform includes at least one of a coaster, a business card, a business menu, a restaurant menu, an event flyer, marketing materials, signs and posters, office stationary, post cards, brochures, rack cards, door hangers, presentation folders, table tents, promo products, bookmarks, office supplies, magnets, promotional materials, labels and stickers, paper and photo coasters.

7. The information providing apparatus of claim 1, wherein the information platform includes at least one of a menu, a cup, a napkin, servingware.

8. A method of providing encrypted information to people, comprising:
sending the information to be encrypted to a server running a customization website;
choosing the look of an information platform;
encrypting the information in a machine readable code;
printing the machine readable code on the information platform;
sending the information platform to a business; and
providing the people with the printed information platform by the business.

9. The method of claim 8, further comprising:
taking an image of the machine readable code by a mobile phone automatically when the machine readable code is detected by the mobile phone.

10. The method of claim 9, further comprising:
running n app on a mobile device for providing a WiFi password directly to a logon screen.

11. The method of claim 8, further comprising:
logging a user of the mobile phone into a Win network.

12. The method of claim 8, further comprising:
determining decorative information that may be printed on the information platform.

13. The method of claim 8, wherein machine readable code is a bar code.

14. The method of claim 8, wherein the machine readable code is a R code.

15. The method of claim 8, wherein the information platform includes at least one of a coaster, a business card, a business menu, a restaurant menu, an event flyer, marketing materials, signs and posters, office stationary, post cards, brochures, rack cards, door hangers, presentation folders, table tents, promo products, bookmarks, office supplies, magnets, promotional materials, labels and stickers, paper and photo coasters.

16. The met claim 1, wherein the information platform includes at least one of a menu, a cup, in, servingware.

17. The information providing apparatus of claim 1, wherein the information platform includes at least one of a coaster and a business card.

18. An information providing apparatus, comprising:
a means for providing information; and
a means for marking the information platform in a form representing a coded machine readable indicia, the coded machine readable indicia having encrypted therein at least a WiFi network password.

19. The information providing apparatus of claim 18, wherein the means for providing information includes decorative elements.

20. The information providing apparatus of claim 18, wherein the means for marking includes a QR code.
